(19) United States
(12) Patent Application Publication
(10) Pub. No.: US 2012/0030552 A1
(43) Pub. Date: Feb. 2, 2012

(54) ATTACHING LINKS TO EMAIL

(75) Inventors: Inbal ZILBERMAN-KUBOVSKY, Ramat-Gan (IL); Yiftach Nun, Dafna (IL)

(73) Assignee: SAP AG, Walldorf (DE)

(21) Appl. No.: 12/848,177

(22) Filed: Aug. 1, 2010

(51) Int. Cl. G06F 17/00

(52) U.S. Cl. 715/205

(57) ABSTRACT

The subject matter discloses a computerized apparatus for linking to an attached file from a text, the apparatus having a processor, the apparatus comprising a receiving module configured to receive an object comprising the text, wherein the object further comprises the attached file, wherein the receiver is further configured to receive a file identification associated with the attached file, wherein the receiver is further configured to determine a representation of the file in the text; a storage device for retaining the object received by the receiving module; a linking module configured to determine a link object, wherein the link object refers to the file, wherein the link object is displayable using the representation of the file; and an applying module configured to modify the object retained in the memory, wherein the applying module is configured to insert in the text the link object determined by the linking module.

### FIELD OF THE INVENTION

The present disclosure relates to email messages and documents, in general, and to attaching documents to email messages and documents in particular.

### BACKGROUND

Email applications such as Microsoft® Outlook™, Google® Gmail™ and the like allow end users to attach files to an email message. An attachment may be a picture, a document, a movie clip, and the like. The email message may be sent to a recipient who may access the attachment.

Files may also be attached to other types of documents different than email messages. For example, a word processing document may comprise attached files.

An email message and similar documents may contain a hyperlink. A hyperlink is a reference to a document, a portion thereof or the like. The hyperlink may be given using a Uniform Resource Locator (URL). A hyperlink may be clickable and enable automatic retrieval of the linked document. For example, a recipient of the email message may click on the hyperlink to instruct the email application to locate the referred resource. The hyperlink may be defined to refer to a local document, such as a file in a local hard drive, a remote document, such as a web page or a file in a shared storage system, a section within a document or the like.

### BRIEF SUMMARY OF THE INVENTION

One exemplary embodiment of the disclosed subject matter is a computerized apparatus for linking to an attached file from a text, the apparatus having a processor, the apparatus comprising a receiving module configured to receive an object comprising the text, wherein the object further comprises the attached file, wherein the receiver is further configured to receive a file identification associated with the attached file, wherein the receiver is further configured to determine a representation of the file in the text; a storage device for retaining the object received by the receiving module; a linking module configured to determine a link object, wherein the link object refers to the file, wherein the link object is displayable using the representation of the file; and an applying module configured to modify the object retained in the memory, wherein the applying module is configured to insert in the text the link object determined by the linking module.

The apparatus further comprising a displaying module configured to display the object and to display the attached file in an attached field according to rules. The representation comprises a name of the attached file.

The representation comprises a first set of characters, wherein a file name of the attached file comprises a second set of characters; and wherein the first set of characters are associated with a different set of characters than the second set of characters. The apparatus further comprising an attaching module configured to attach the attached file to the object in response to a determination that the attached file is not attached to the object.

Another exemplary embodiment of the disclosed subject matter is a computer-implemented method for linking an attached file from a text, the method performed by a processor, the method comprising receiving an object comprising the text; receiving a file identification of the file; receiving a pointer to the file; linking between the file identification of the file and the pointer of the file; and applying the linkage to the object; wherein the file 3D being attached to the object. The linking comprising creating a hyperlink. The receiving of the pointer to the file is performed automatically according to the file identification and further comprising providing a user interface for manually choosing the file. The method further comprising removing attachment of the file from an attached field of the email message. The linking further comprising linking a non attached file and attaching the file to the object. The object is a email message or a document.

Another exemplary embodiment of the disclosed subject matter is a computer program placed on a magnetic readable media for linking an attached file from a text, the computer program comprising a first program instruction for receiving an object comprising the text; a second program instruction for receiving a file identification of the file; a third program instruction for receiving a pointer to the file; a forth program instruction for linking between the file identification of the file and the pointer of the file; and a fifth program instruction for applying the linkage to the object, wherein the file being attached to the object and wherein the object being a email message or a document and wherein the first, second and third program instructions are stored on the computer readable medium.

### BRIEF DESCRIPTION OF HE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a schematic drawing of a computerized apparatus for linking an attached file from a text, in accordance with some exemplary embodiments of the subject matter;

FIG. 2 shows a schematic drawing of a computerized implemented method for linking an attached file from a text, in accordance with some exemplary embodiments of the subject matter; and

FIG. 3 shows an exemplary screen of an email message with references to files from the text of the message.

### DETAILED DESCRIPTION

One technical problem dealt with by the disclosed subject matter is to refer to an attached file from a text section of a document. In one embodiment the text section may be a text of an email message and the attached file may be a file attached to the mail message. In another embodiment the document may be any document such as, for example, Microsoft® Word document a Microsoft® Excel™ document and the like and the attached file may be a file attached to the document.

One technical solution comprises determining a link to the attached file. The link is inserted in a text section of a document which comprises the attached file. The link is configured to refer to the attached file which is comprised by the document in which the link is placed. Another technical solution is to determine the link based on a file identification of the attached file. Yet another technical solution is to determine the link to be represented by a representation. The representation may be a name of the attached file, an alias to the name of the attached file or the like. The representation may be embedded in the text of the document. Yet another technical solution is to automatically determine, based upon user input, that a text that is inserted to the document, is associated with an attached file. The inserted text may comprise, for example, the name. Yet another technical solution is to determine the link based on a user indication. The user indication may be, for example, a user choosing to link to a file from a list of files, such as a list of files attached to the document, a list of files capable of being attached to the document or the like. Yet another technical solution is to further attach the attached file to which the link refers.

One technical effect of utilizing the disclosed subject matter is referring within the text section of a document to a file that is attached to the document. Another technical solution is to provide a recommended order to review the attached file and portions of the text section, such as first review a first portion, then review the attached file and finally review a second portion. Yet another technical solution is to provide a link to the attached file, the link is represented using a different representation than the file name of the attached file. The file name of the attached file may not be understandable, readable, and indicative of the content or the like. The file name may be written in a different language, using different encoding, or the like. For example, the file name may be written in non-Latin characters while the text may be written in Latin characters. In such a case, the representation of the like may be written in the language used in the document.

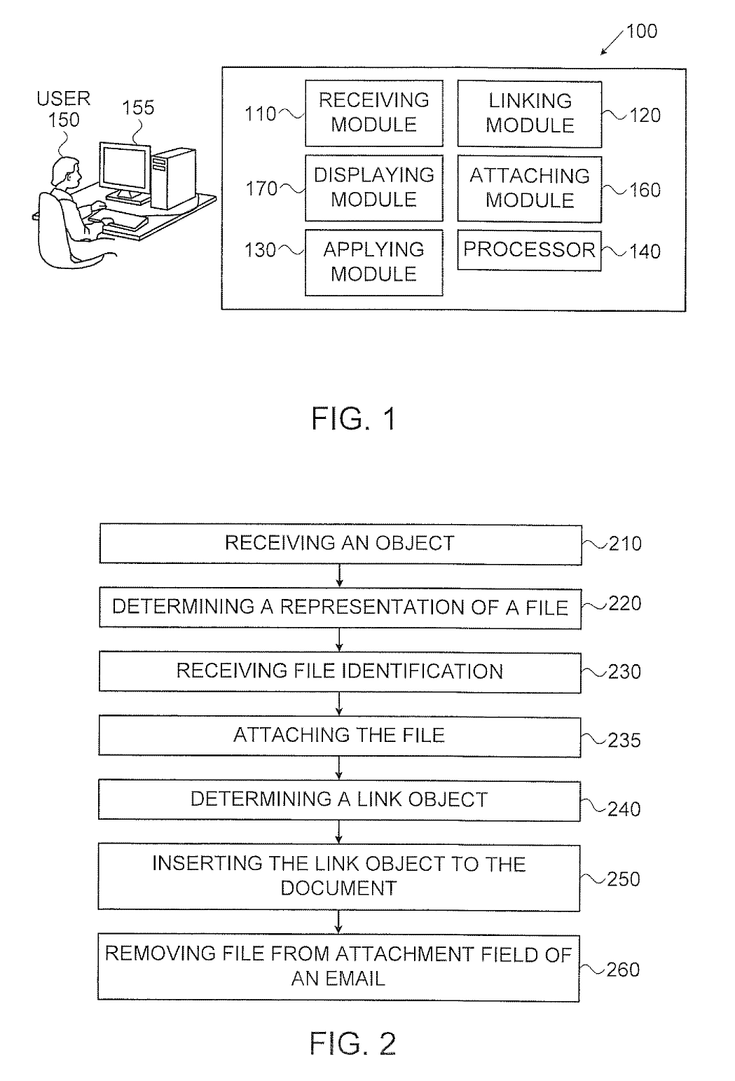

FIG. 1 shows a schematic view of a computerized apparatus for referring to an attached document from a text, in accordance with some exemplary embodiments of the subject matter.

Apparatus 100 may comprise a receiving module 110. The receiving module 110 may be configured for receiving a document object comprising a text.

The receiving module 110 may be configured to receive a representation of a file, such as a text to be displayed in a link to the file. In some exemplary embodiments, the representation of the file may be an alias to the file. The representation may comprise the name of the file. Alternatively, the representation may not be related to the name of the file. For example if the file name is finance.xls and the file content relates to payments, the file representation may comprise “finance.xls” or may be unrelated to the fine name, such as for example “payment file”.

The receiving module 110 may be configured to receive an identification of a file, such as a pointer, an i-node, a file handler, a file name, or the like.

In some exemplary embodiments, the receiving module 110 may be configured to determine the identification of the file in response to identifying the file from the representation. For example, in case the representation is “finance.xls” and a file with the same name is attached to the document, the receiving module 110 may determine the file identification without receiving input from a user 150. Such automatic retrieval can be done, for example, by retrieving the address of the file from the metadata of the document. The retrieving may be done by searching a file system according to the file name. The file identification may be retrieved based on user 150 input, such as selection of a file using a Graphical User Interface (GUI). In some exemplary embodiments, the GUI may provide a display of a list of files to the user 150, such as for example, a list of files located in a file system, in a folder, or the like. In some exemplary embodiments the list of files may comprise files that are attached to the document. In some exemplary embodiments, in case the user 150 indicates a file which is not attached to the document, an attaching module 160 may be configured to attach the file to the document.

The apparatus 100 may comprise a linking module 120 configured to determine a link object referring to the attached file. The linking module 120 may determine the link object based on the identification of the file, such as to determine the file to which the link refers. In some exemplary embodiments, the link object may be a hyperlink, comprising a textual representation, such as the representation received or determined by the receiving module 110. The link object may further comprise a meta-data identifying the referred file. In some exemplary embodiments, the hyperlink may be represented using a clickable object, such as a clickable text.

In some exemplary embodiments, the hyperlink may be formatted using a predetermined format. For example “attach://filename”, where “attach://” is a predetermined prefix representative of a hyperlink that refers to an attached file, and “filename” is a name of the attached file, or a similar file identification to identify the referred file. The exemplary format shown above is in line with standard URL formats. However, other formats may be defined and utilized.

The apparatus 100 may comprise an applying module 130. The applying module 130 may be configured to apply the link object determined by the linking module 120, to a text section of a document, such as obtained by the receiving module 110.

The applying module 130 may embed within the text of the document the representation of the link object and provide pertinent meta-data indicating that the representation is a representation of the link object. For example, the representation may be textual representation, such as a string of characters. The string may be inserted to the text of the document in a location, such as a current location, a pointed location, or the like. The string may be configured to be clickable and to indicate upon a click, of the attached file being linked. The indication may be provided using a predetermined format such as “attach://filename”.

In some exemplary embodiments, an attached file may be represented in a document in a predetermined section, such as an attachment field of an email message. The applying module 130 may also be configured to remove the attached file referred to by the link object from the attachment field.

In some exemplary embodiments, the linking object determined by the linking module 120 may be operative to initiate a predetermined operation. For example, upon clicking on a hyperlink, a transaction may be initiated, such as an acknowledgment transaction which is configured to indicate to the sender that the attached file was received and opened.

The apparatus 100 comprises a processor 140 such a Central Processing Unit (CPU), an Integrated Circuit (IC), an electric circuit or the like. The processor 140 may be configured to perform any computations or processing required by the apparatus 100 or any of its subcomponents.

In some exemplary embodiments, the user 150 may interact with the apparatus using a Man-Machine Interface (MMI) 155. The MMI 155 may comprise an input device, such as a pointing device, a keyboard, a touch screen or the like. The MMI 155 may comprise an output device such as a display, a printer or the like. The user 150 may provide user input to the apparatus 150 using the MMI 155. The user 150 may use the MMI 155 to review output provided by the apparatus 100 such as a document modified after the link object is inserted into the document, or the like.

The apparatus 100 may comprise a displaying module 170 for displaying the email message and for displaying the attached file in an attached field of the email message. The displaying of the attached file is performed according to rules. Such rules may be, for example, never display attached files, display only specific attached files or display files according to the user selection.

FIG. 2 shows a schematic drawing of a computerized implemented method for referring to an attached document from a text, in accordance with some exemplary embodiments of the subject matter.

In step 210, an object may be received. The object may be a document, an email message or the like. Receiving the object may comprise receiving metadata regarding the object. The object may comprise a text section from which an attached file is to be referred to. Step 210 may be performed by a receiving module, such as 110 of FIG. 1.

In step 220, a representation of the file may be determined. The representation may be determined based upon user input. The representation may be determined by a receiving module, such as 110 of FIG. 1. The representation may include a textual identification of the file, a URL (e.g., attach://filename), a string, an alias or the like. In some exemplary embodiments, step 220 may comprise determining the representation by extracting the textual identification from the text, for example using pattern matching.

In step 230, the file identification may be received. The file identification may comprise an address of the file, a pointer to the file, a file handler or the like. The file identification may be determined based upon a file name. For example, the file identification may be determined based on a file that is attached to a document and corresponds to a textual representation determined in step 220.

In some exemplary embodiments, the file identification may be extracted from the metadata of the document if the file is already attached to the document and if the textual representation comprises the file name. In such a case, extracting may be done by searching the file name in the metadata of the document. Alternatively, the extracting may be done b′ providing a GUI for browsing through files and for selecting a file. Browsing may be done from a list of files that are attached to the document and/or files that are retained in a storage system such as in a local computer, in a remote computer, in a remote storage system, in a distributed storage system, in a computerized network, on the Internet or the like.

In step 235, the file identified in step 230 may be attached to the document. The file may be attached by an attaching module, such as 160 of FIG. 1. In some exemplary embodiments, in case the file is not previously attached to the document, the document may be modified to further comprise the file as an attachment.

In step 240, a link object may be determined. The link object may be determined by a linking module, such as 120 of FIG. 1. The link object may refer to the attached file identified in step 230. The link object may be configured to be represented using the representation determined in step 220. The link may refer to the attached file using a URL or a similar format.

In step 250, the link object determined step 240 may be inserted to the document. The document may be modified to further include the link object. A text section of the document may be modified to include the textual identification of the link object. The document may be configured to provide a functionality upon clicking the textual identification. The link object may be added to the document by an applying module, such as 130 of FIG. 1.

In step 260, the representation of the file may be removed from the attachment field of the email. In some exemplary embodiments, a software product operative to display the document may be configured to provide a display such that the attached file referred to by the link object is not displayed in the attachment field.

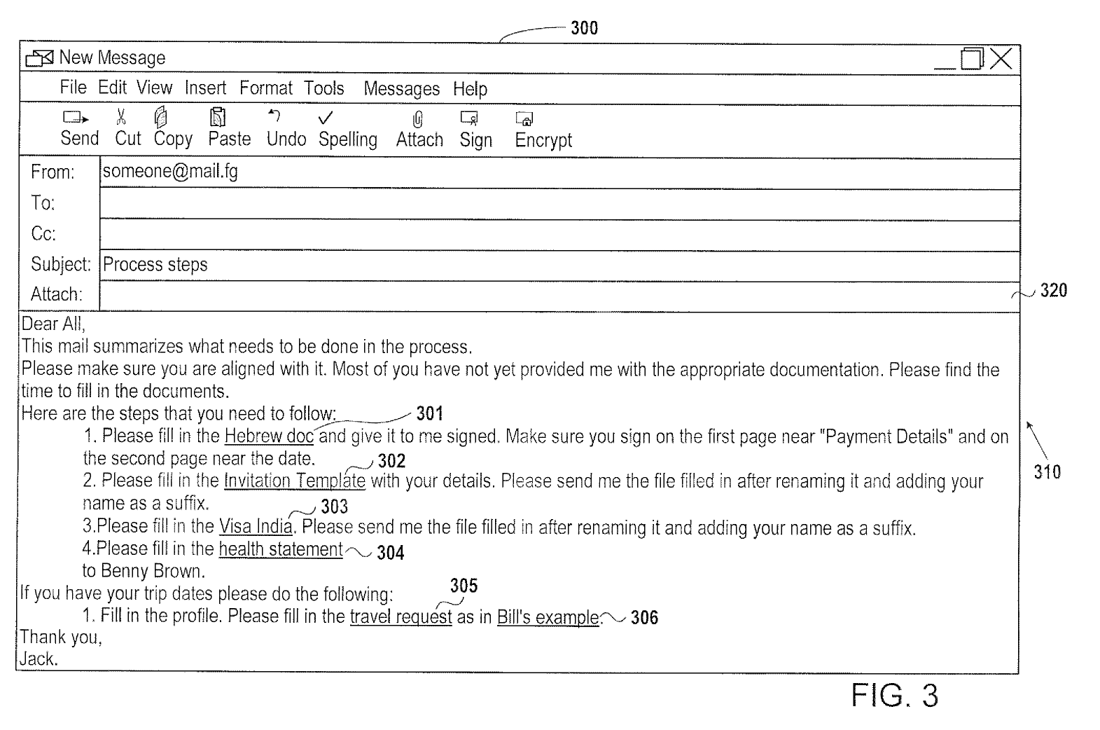

FIG. 3 shows an exemplary screen of an email message with references to files from the text of the message.

An email message 300 comprises a text section 310. The text section 310 comprises a text of the email message 300. In accordance with the disclosed subject matter,

In the exemplary figure the files can be retrieved only clicking on the link, since the files are not displayed in attachment field of the mail. Email message 300 comprises links 301, 302, 303, 304, 305, 306. Each file has a textual representation: the first link 301 has a textual reference “Hebrew doc” to a first attached file, the second link 302 has a textual reference “Invitation Template” to a second attached file, the third link 303 has a textual reference “Visa India” to a third attached file, the fourth link 304 has a textual reference “health statement” to a fourth attached file, the fifth link 305 has a textual reference “travel request” to a fifth attached file and the sixth link 306 has a textual reference “Bill's example” to a sixth attached file. Each reference comprises a hyperlink to the pertinent attached file. Each of links 301-306 is clickable and in response to a click the pertinent file may be accessed.

In some exemplary embodiments, the textual reference of a link may not comprise the file name of the referred file. For example, the file referenced by “Hebrew doe” 303 may have a Hebrew file name which may comprise Hebrew characters. As the recipient of the email message 300 may not know Hebrew, an alternative textual reference, also referred to as an alias, is provided. In addition, in some eases, due to a use of a different set of characters, non-Latin characters may not be viewable by an email client of the recipient from different reasons. For example, an appropriate encoding may not be available for the email client. As another example, a coding of the characters may not be transmitted correctly, thus hindering the email client from displaying them correctly. Other reasons may also cause the same effect.

An attachment field 320 may comprise attached files. In some exemplary embodiments, attached files which are referred to by a link, such as link 301, may not be displayed in the attachment field. In other exemplary embodiments, attached files are displayed in the attachment field on top of being accessible using the links in the text section 310.

While the disclosure has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings without departing from the essential scope thereof. Therefore, it is intended that the disclosed subject matter not be limited to the particular embodiment disclosed as the best mode contemplated for carrying out this invention, but only by the claims that follow.

What is claimed is:

1. A computerized apparatus for linking to a file from a text, the apparatus having a processor, the apparatus comprising:
a receiving module configured to receive an object comprising the text, wherein the object further comprises the file, wherein the receiving module is further configured to receive a file identification associated with the file, wherein the receiving module is further configured to determine a representation of the file in the text;
a storage device for retaining the object received by the receiving module;
a linking module configured to determine a link object, wherein the link object refers to the file, wherein the link object is displayable using the representation of the file; and
an applying module configured to modify the object retained in the storage device, wherein the applying module is configured to insert in the text the link object determined by the linking module and wherein the file is an attached file.

2. The apparatus according to claim 1, further comprising a displaying module configured to display the object and to display the file in an attached field according to rules.

3. The apparatus according to claim 1, wherein the representation comprises a name of the file.

4. The apparatus according to claim 1, wherein the representation comprises a first set of characters, wherein a file name of the file comprises a second set of characters; and wherein the first set of characters are associated with a different set of characters than the second set of characters.

5. The apparatus according to claim 1 further comprising an attaching module configured to attach the file to the object in response to a determination that the file is not attached to the object.

6. A computer-implemented method for linking a file from a text method performed by a processor, the method comprising:
receiving an object comprising the text;
receiving a file identification of the file;
receiving a pointer to the file;
linking between the file identification of the file and the pointer of the file; and
applying the linkage to the object; wherein the being attached to the object.

7. The method according to claim 6, wherein the linking comprising creating a hyperlink.

8. The method according to claim 6, wherein receiving, the pointer to the file being performed automatically according to the file identification.

9. The method according to claim 6, wherein the receiving the pointer to the file further comprising providing a user interface for manually choosing the file.

10. The method according to claim 6, further comprising removing attachment of the file from an attaching field of the email message.

11. The method according to claim 6 wherein the linking further comprising linking the file and attaching the file to the object.

12. The method according to claim 6, wherein the object being a email message or a document.

13. A computer program placed on a magnetic readable media for linking a file from a text, the computer program comprising:
a first program instruction for receiving an object comprising the text;
a second program instruction for receiving a file identification of the file;
a third program instruction for receiving a pointer to the file;
a forth program instruction for linking between the file identification of the file and the pointer of the file; and
a fifth program instruction for applying the linkage to the object, wherein the file being attached to the object and wherein the object being a email message or a document and wherein the first, second and third program instructions are stored on the computer readable medium.
